(19) United States
(12) Patent Application Publication
(10) Pub. No.: US 2014/0080082 A1
(43) Pub. Date: Mar. 20, 2014

(54) LIGHT CURE BITE PLATE FOR ORTHODONTIC REMODELING DEVICES

(71) Applicant: ORTHOACCEL TECHNOLOGIES INC., Bellaire, TX (US)

(72) Inventor: Michael K. LOWE, Bellaire, TX (US)

(73) Assignee: ORTHOACCEL TECHNOLOGIES INC., Bellaire, TX (US)

(21) Appl. No.: 13/967,043

(22) Filed: Aug. 14, 2013

Related U.S. Application Data
(60) Provisional application No. 61/701,532, filed on Sep. 14, 2012.

(51) Int. Cl. A61C 7/00; A61C 13/15; A61C 7/08

(52) U.S. Cl. CPC A61C 7/008; A61C 7/08; A61C 19/003
USPC 433/6

(57) ABSTRACT

Improved customizable bite plates using curable resins, especially light curable resins, for use with orthodontic vibratory devices.

### PRIOR RELATED APPLICATIONS

This application claims priority to 61/701,532, filed Sep. 14, 2012, and expressly incorporated by reference in its entirety.

### FEDERALLY SPONSORED RESEARCH STATEMENT

Not applicable.

### FIELD OF THE INVENTION

This invention relates to customizable bite plates that can be used with any device used for orthodontic remodeling.

### BACKGROUND OF THE INVENTION

A malocclusion is a misalignment of teeth or incorrect relation between the teeth of the two dental arches. The term was coined by Edward Angle—the father of modern orthodontics—as a derivative of occlusion, which refers to the way opposing teeth meet. Angle based his classifications of malocclusions on the relative position of the maxillary first molar. According to Angle, the mesiobuccal cusp of the upper first molar should align with the buccal groove of the mandibular first molar. The teeth should all fit on a line of occlusion, which is a smooth U-shaped curve through the central fossae and cingulum of the upper canines, and through the buccal cusp and incisal edges of the mandible. Any variations therefrom results in malocclusion.

There are three classes of malocclusions, Class I, II, and III. Further, class II is subdivided into three subtypes:

Class I: Neutrocclusion Here the molar relationship of the occlusion is normal or as described for the maxillary first molar, but the other teeth have problems like spacing, crowding, over or under eruption, etc.

Class II: Distocclusion (retrognathism, overjet) In this situation, the upper molars are placed not in the mesiobuccal groove, but anteriorly to it. Usually the mesiobuccal cusp rests in between the first mandibular molars and second premolars. There are two subtypes:

Class II Division 1: The molar relationships are like that of Class II and the anterior teeth are protruded.

Class II Division 2: The molar relationships are class II but the central incisors are retroclined and the lateral incisors are seen overlapping the central incisors.

Class III: Mesiocclusion (prognathism, negative overjet) In this case the upper molars are placed not in the mesiobuccal groove, but posteriorly to it. The mesiobuccal cusp of the maxillary first molar lies posteriorly to the mesiobuccal groove of the mandibular first molar. This malocclusion is usually seen when the lower front teeth are more prominent than the upper front teeth. In such cases, the patient very often has either a large mandible or a short maxillary bone.

Orthodontics, formerly orthodontia (from Greek orthos “straight or proper or perfect”; and odous “tooth”), is the first specialty of dentistry that is concerned with the study and treatment of malocclusion, which can be a result of tooth irregularity, disproportionate facial skeleton relationship, or both. Orthodontics treats malocclusion through the displacement of teeth via bony remodeling and control and modification of facial growth.

This process has been traditionally accomplished by using static mechanical force to induce bone remodeling, thereby enabling teeth to move. In this approach, braces that consist of an archwire interfaces with brackets that are affixed to each tooth. As the teeth respond to the pressure applied via the archwire by shifting their positions through bone remodeling, the wires are again tightened to apply additional pressure. This widely accepted approach to treating malocclusion takes about twenty-four months on average to complete, and is used to treat a number of different classifications of clinical malocclusion. The time for treatment cannot be shortened by applying more force, due to discomfort and the high risk of root resorption with excess force.

Treatment with braces is complicated by the fact that it is uncomfortable and/or painful for the patients, and the orthodontic appliances are perceived as unaesthetic, all of which creates considerable resistance to use. Additionally, the 24-month treatment time is very long, and further reduces usage. In fact, some estimates provide that less than half of the patients who could benefit from such treatment elect to pursue orthodontics.

Kesling introduced the tooth positioning appliance in 1945 as a method of refining the final stage of orthodontic finishing after removal of the braces (debanding). The positioner was a one-piece pliable rubber appliance fabricated on the idealized wax set-ups for patients whose basic treatment was complete. Kesling also predicted that certain major tooth movements could also be accomplished with a series of positioners fabricated from sequential tooth movements on the set-up as the treatment progressed. However, this idea did not become practical until the advent of 3D scanning and computer modeling in 1997, when the Invisalign® system was introduced by Align Technologies®.

In addition to static forces, cyclic forces can also be used for orthodontic remodeling. Kopher and Mao assessed cyclic forces of 5N peak magnitude at 1 Hz in rabbits, while Peptan and Mao assessed cyclic forces of 1N at 8 Hz in rabbits, and Vij and Mao assessed cyclic forces of 300 mN at 4 Hz in rats. In aggregate, the data from these three studies indicated that cyclic forces between 1 Hz and 8 Hz, with forces ranging from 0.3N to 5N, increased bone remodeling. Rates depended on different methodologies, but increases of 2.5× with vibrational forces were common.

Since Dr. Mao's experiments, an independent study out of Japan has confirmed and strengthened the idea of vibration at 60 Hz for speeding bone remodeling, and an earlier 50 Hz study in Russia also confirms the basic premise. In fact, by now there is a well established literature confirming the efficacy of this treatment modality.

The early Mao studies provided a basis for both possible efficacy and likely safety for using vibration in humans to assist orthodontic tooth movement, but the animal studies needed to be repeatable in humans, and the devices used therein (cranial clamps) were completely unsuitable for clinical work. Further, the Mao experiments only assessed cranial suture osteogenesis, not actual tooth movement. Thus, although suggestive, a device still had to be designed, built and actually tested in humans, and it needed to be proven that vibration did not cause root resorption, which tends to be problematic if too much force is applied.

OrthoAccel® Technologies Inc., invented the first commercially successful dental vibrating device, as described in US20080227046 and related cases, designed to apply cyclic forces to the dentition for accelerated remodeling purposes. Both intra-oral and extra-oral embodiments are described in US20080227046, each having processors to capture and transmit patient usage information.

The bite plate was specially designed to contact occlusal as well as lingual and/or facial surfaces of the dentition, and thus was more effective than any prior art devices in conveying vibrational forces to the teeth. Further, the device has actually been tested in clinical trials and has been shown to speed orthodontic remodeling as much as 50%, without root resorption, and is truly a breakthrough in orthodontic technology (Kau 2010).

Finally, the device is slim, capable of hands free operation, lacks the bulky head gear of the prior art devices, and has optimized force and frequency for orthodontic remodeling. Thus, its comfort level and compliance was also found to be high, with patients reporting that they liked the device, especially after the motor was redesigned to be quieter and smoother, as described in US20100055634 et seq. In fact, this device has been marketed as AcceleDent® in Australia, the United Kingdom, Europe, China, South Korea, Japan, Kenya, and the United States and has achieved remarkable commercial success since its recent introduction (2009). AcceleDent™ represents the first successful clinical approach to accelerate orthodontic tooth movement by modulating bone biology in a non-invasive and non-pharmacological manner.

Although compliance with the AcceleDent is fairly good, with certain patients compliance is less than satisfactory. On investigating the basis for non-use, OrthoAccel discovered that a poorly fitting bite plate reduced compliance because the extra-oral vibratory source, coupled with a poorly fitting bite plate, resulted in excessive salivation, which tended to egress from the oral cavity.

WO2011056260 attempted to solve this problem with a series of bite plates in a small, medium and large size together with open, flat and deep bite plate architecture, thus providing a series of 9 bite plates that fit a significant percentage of the population. While this solution is one viable option, it requires tooling up and inventory for a substantial number of bite plates, and further still is less than a perfect solution for extreme malocclusions or unusual facial structures.

Custom dental appliances are, of course, readily available, as indicated by the aligner and positioner markets. However, these products require 3D modeling and/or custom impressions made of the dentition and some time in an offsite laboratory facility to make the custom fitted appliance.

Therefore, what is needed in the art is a truly customizable bite plate that can be individually fitted to each patient, without a significant time investment needed by the patient or practitioner. This application addresses some of those needed improvements.

### SUMMARY OF THE DISCLOSURE

The disclosure is directed to a custom bite plate that has a base layer of a soft, light-curable resin, such that the patient can bite on the plate to fit the base to the occlusal, facial and lingual teeth surfaces of both arches, and then light cured to provide a custom fitted plate. Since light curing is very fast, the device can be fitted and made ready for use in a very short period of time, allowing the patient to purchase and leave with a custom fitted vibrating dental appliance that can reduce their orthodontic treatment time by 50%.

At a minimum, the prior art bite plate should be fitted with a layer of 1-5 mm, preferably 2-4 mm, of light or otherwise curable resin on at least the base (occlusal) surfaces. However, it may also be desirable in extreme cases to have a layer of such resins that contact facial and lingual teeth surfaces, although in some cases, total contact may not be necessary, especially since a layer of resin on the occlusal surface will spread to contact at least the edges of the facial and lingual surfaces, if not their totality.

The layer of curable resin allows the bite plate to accommodate open bites, deep bites and flat bites, and thus provides each patient with the best fit for the bite plate, reducing or even eliminating any drooling.

The customizable bite plate can be used with the existing extra-oral vibrational device, which is already cleared for marketing in the US and several other places. However, the same principles can be applied to a completely intra-oral device, wherein the vibratory source and power source are mounted on the bite plate.

The bite plate can be assembled using the existing inner core (or inner core and coating) shaped to contact at least occlusal surfaces and preferably at least one of the facial and lingual surfaces. A layer of curable resin is added before packaging in e.g., a light-proof foil package. Alternatively, the resin can be in liquid or paste form and added to the plate as needed in the office. However, since this increases chair time, it is believed to be less desirable. On the other hand, most dental offices already have a variety of quick curing resins available, and this may be a cost effective alternative for easily customizing existing bite plate inventory.

In alternative embodiments, the adhesives can be self-curing, dual curing and vacuum, moisture, heat and pressure curable compositions as well as any combination thereof, to name but a few curable compositions. The most popular moisture cured resins are cyanoacrylates, silicones, and polyurethanes. However, light cure is currently preferred since most dental offices already have a substantial investment in light cure devices and light cure allows controlled, fast curing.

In order for a light cure adhesive to react to UV or visible light, a chemical called a photo-initiator must be present in the formulation. Light emitted from a suitable source causes the photo-initiator to fragment into reactive species. These fragments initiate a rapid polymerization process with monomers and oligomers in the system to form a cross-linked, durable polymer.

Radiant energy that may be usefully employed to initiate polymerization (cure) include electron beam radiation, ultraviolet (UV) radiation, visible light radiation, gamma radiation, X-rays, and beta-rays. VL/NIR (Visible Light/Near IR) is another option. Preferably, photo-curing radiation comprises UV light (100-400 nm) and visible light (400-760 nm). Even more preferably, cure is affected with UVA or blue light, which is already available in most clinics.

The primary advantage of using light curable resins is the speed of cure. Depending on the product and system, cures can be achieved within seconds. In addition, light curable resins are one-part systems, eliminating the need to measure or mix compounds and associated concern over shelf-life of such compounds. Light curable resins are also solvent-free, reducing the risk of undesired effects on the oral environment. In fact, many currently available light curable adhesives are USP Class VI approved for medical use based on ISO 10993-Elution, Systemic Injection, Intracutaneous, Implantation and Hemolysis testing. Once cured, these resins provide excellent moisture and humidity resistance, important features for use in the oral environment.

Light curing can be achieved with the use of any suitable light curing system. Most commercial light curing systems include a light source (lamp), an irradiator (lamp housing and reflector assembly), a power supply and electrical controls, shielding and cooling equipment, and conveyor and/or auxiliary equipment. The particular type of lamp used should have a spectral output that matches the pattern of absorption of the photo-initiator in the adhesive. Lamps are available in modular, free-standing, bench-top or custom designs. Generally, spot wand lamps are the most convenient for use in the orthodontic office or laboratory since they typically have connectable light guides for directing the light to a desired location for curing. The light guides can be hand-held for complete mobility, or clamped into position for repetitive operations. Thus, the curing system requires little space and minimal energy, unlike large thermal ovens associated with heat curing which are expensive to operate.

A large number of suitable light curable resins or adhesives are already commercially available. The most preferred materials are medical grade or FDA cleared for oral use and are tasteless, non-toxic, biocompatible and curable with UVA or blue light. Suitable resins may include an epoxy, a cyanoacrylate, an acrylate, a urethane, an acrylate and urethane mixture, a urethane oligomer/(meth)acrylate monomer blend resin, a silicone, a silicone copolymer, or a copolymer of hydrogen siloxanes and unsaturated compounds.

Alternatively, the resin may comprise copolymers of hydrogen siloxanes and unsaturated compounds. These may be used as adhesion promoters to build a chemical link between the resin and the bite plate. An example of such an adhesive is described in DE19934117 and incorporated by reference herein for all purposes. Other resins are described in e.g., U.S. Pat. No. 5,856,373; 20110200973; U.S. Pat. No. 5,017,626; U.S. Pat. No. 4,459,193; U.S. Pat. No. 4,411,625; U.S. Pat. No. 4,771,084; US20050049326.

Light curable resins include e.g., Eclipse® and Triad® from Dentsply®. However, softer versions of such materials may be preferred, thus accommodating the incremental tooth movement, as dental remodeling proceeds. Hardness can easily be varied, by e.g., controlling the degree of crosslinking. Alternatively, multiple bite plates can be used throughout the treatment, as is currently done for aligners, and particularly if the price point is sufficiently low.

Ultraviolet-curing silicon resins are composed of siloxane as the main chain, and alkoxysilane, which is a moisture reactive functional group, and the methacryloyl group, which is an ultraviolet-curing functional group, as the terminals. The formulation is comprised of the oligomer having the structure shown in FIG. 6, a moisture-curing catalyst, a light-initiator, a filler, an adhesion improver, and a stabilizer.

These resins cause radical polymerization when irradiated with ultraviolet light, or cause demethanolization condensation when exposed to moisture in air to form cross-links.

Preferable, the resin self adheres to the bite plate, but for those resins that do not sufficiently adhere, they can be attached to the bite plate with a layer of adhesive and the like.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated. In the context of specific dimensions of parts, the term “about” includes that amount of tolerance that still allows the parts to operably fit together. Tolerances may be somewhat higher for flexible materials, e.g., silicone rubbers, than for harder materials, e.g., metals.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention. Thus, the term consisting essentially of excludes only material elements, such as headgear or toothbrush bristles.

The following abbreviations are used herein:

| Abbreviation | Expansion |
|---|---|
| TEGDMA | Triethylene glycol dimethacrylate |
| BIS-GMA | Bisphenol A glycidyl methacrylate |
| PS | Polystyrene |
| PP | Polypropylene |
| PE | Polyethylene |
| PVC | Polyvinyl chloride |
| PU | polyurethane |

### BRIEF DESCRIPTION OF THE DRAWINGS

FIGS. 1A and 1B show a perspective view of a prior art bite plate from two different angles.

FIG. 1C shows the same prior art bite plate from a top plan view.

FIG. 2A-B shows a perspective view of the inner core of the bite plate from two different angles.

FIG. 3A-C shows the dimensions of the bite plate, and especially the connector elements.

FIG. 4A-C shows a simple inner core, lacking rims in 4A, with a bead of light-curable resin thereon, fitting to a tooth in 4B, and the resulting final shape in 4C which contacts occlusal as well as lingual and facial surfaces at the occlusal edges.

FIG. 5A-D shows cross sections of various bite plates of the invention, with a curable resin layer that can be customized to fit the patient.

FIG. 6 shows an exemplary ultraviolet-curing silicon resin.

### DETAILED DESCRIPTION OF THE INVENTION

The invention is a customizable bite plate, having the characteristics of the special prior art bite plates described in US20080227046, US20080227047, US2010055634, US20110136070, US20120040300, US20130059263 and US20130322018, 61/624,242, 61/615,480 61/824,798, and 61/673,236 and intended to be used with intra-oral or extra-oral vibratory or other treatment modality sources, as described in the preceding applications for patent, each incorporated by reference in their entireties.

Thus, the invention is an intra-oral bite plate for an orthodontic appliance comprising:
i) a substantially U-shaped surface for contacting occlusal surfaces of teeth;
ii) said U-shaped bite plate having an outside edge having upper and lower rims to contact an upper and lower facial surfaces of teeth and gums;
iii) said U-shaped bite plate having an inside edge having optional upper and lower rims to contact at least a portion of an upper and lower lingual surfaces of teeth and gums;
iv) wherein said U-shaped surface has a layer of light-curable resin thereon, such that said bite plate can be customized to fit a patient, and
v) wherein the bite plate has a connector thereon for reversibly coupling to an extra-oral component, preferably an orthodontic remodeling component as described by OrthoAccel.

In other embodiments, the upper and lower rims also have a layer of light curable resin thereon, thus making the entirety of the teeth facing surfaces custom fittable. However, if the layer or bead of light-curable resin on the occlusal surface is sufficient, it will bleed onto facial and lingual surfaces on fitting, at least at the occlusal edges, and thus it may not be needed to coat the rims.

In other embodiments, the rims can be omitted entirely, but having at least one rim to contact facial or lingual teeth surface is preferred for comfort, placement (having at least one rim helps to hold the device in place), and adequate force transmission in a vibratory device. Further, the rims are expected to help contain the light-curable resin, and thus at least small rims of 1-2 mm or 1-5 mm are preferred, although a thicker resin will obviate this need.

In yet other embodiments, the bite plate can have an inner core that provides the connector and base for the occlusal surfaces and an outer coating that provides the remainder of exterior bite plate shaping. In other embodiments, the inner core can also provide some or all of the rim shaping.

In other embodiments, the invention is an orthodontic remodeling device, comprising:
a) an extra-oral vibratory source;
b) an extra-oral processor that controls said vibratory source and captures and transmits usage data;
c) a power source that drives said vibratory source;
d) an intra-oral bite plate, as described herein,
e) said extra-oral vibratory source being coupled to the intra-oral bite plate;
f) wherein said orthodontic remodeling device is hermetically sealed or in a waterproof housing or at least a water resistant housing and can vibrate at a frequency of 0.1-400 Hz, or 5-30 Hz or 20-40 Hz or 30 Hz, and at a force of 0.1-0.5 Newtons, or 0.1-0.3 Newtons or 0.2-0.25 Newtons.

In yet other embodiments, the bite plate has fitted thereon one or more e.g., coin vibrators or other tiny vibratory source(s), which is operably coupled to one or more coin battery(s) or charged capacitor(s), which are operably coupled to an optional processor for controlling the device and monitoring usage compliance. Thus, the entire device is intra-oral and of customizable fit.

In yet other embodiments, the device uses other treatment modalities in place of or in addition to pulsed or cyclic forces (aka vibration). Thus, the device can be fitted with IR light source, EM field source, microelectronic pulse source, and the like. However, in preferred modalities, the device includes a vibrational source, since vibration has already been proven in clinical trials to reduce remodeling time by 50%.

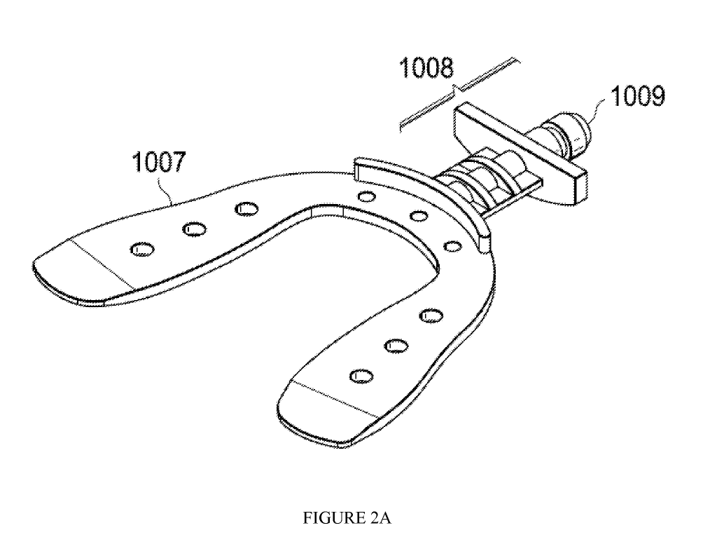

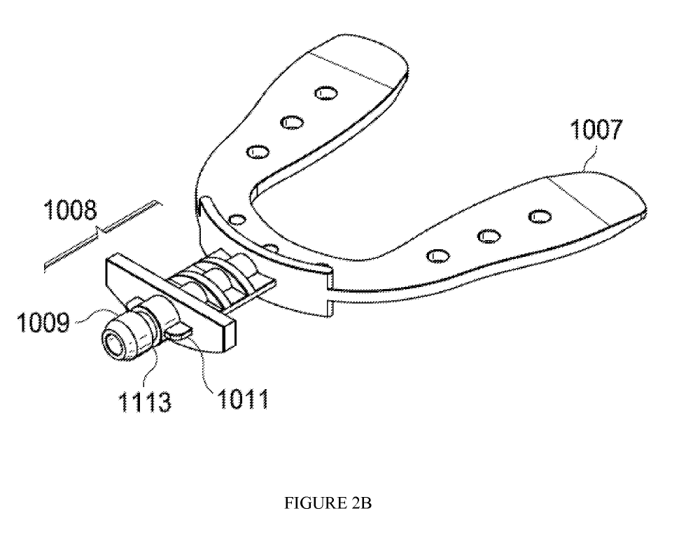

A prototype bite plate is hand made by applying a bead of Dentsply® light curable resin (Triad® and/or Eclipse®) to the inner core shown in FIG. 2A. Patients with severe malocclusion and a tendency to drool with the commercially available bite plate are selected to test the customizable bite plate. Each patient gently bites the plate to custom fit it to their own dentition. The bite plate is removed and then cured in a commercial light curing chamber. The patient then uses the vibrating orthodontic remodeling device for twenty minutes, and the amount of drool is measured using the bib weighing technique and/or the Drooling Impact Scale. As a comparison, the amount of drool produced using the commercial bite plate is also measured, and every data point is collected in at least triplicate. It is expected that the custom fitting plate will reduce saliva by 50-100% (preferably at least 75, 80 or 85%), although patients with extreme inclination of the maxillary incisors may still experience some saliva egress.

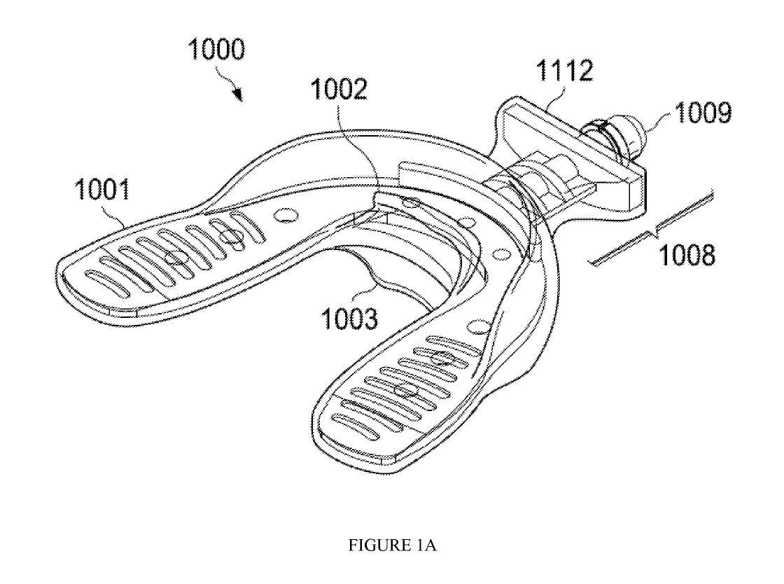

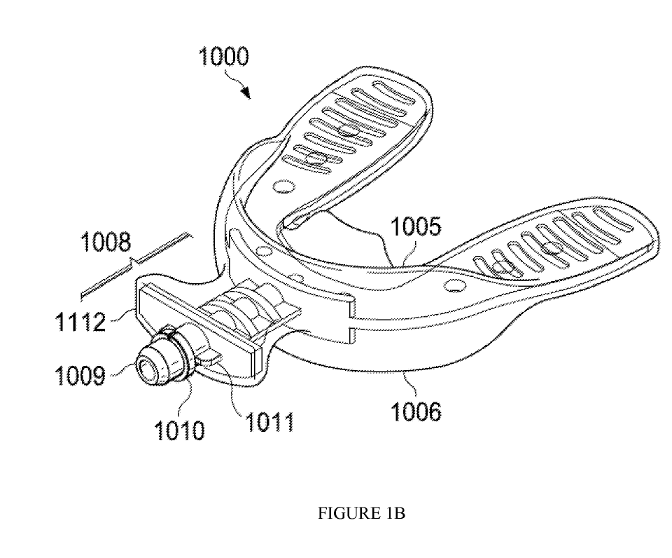

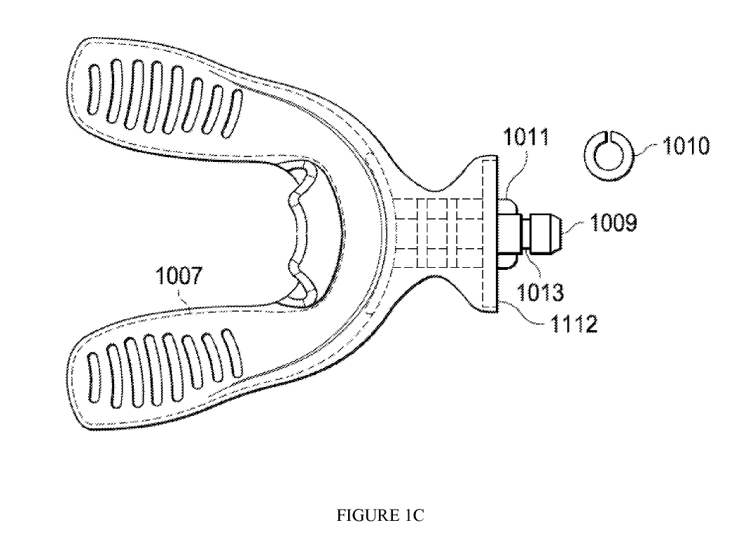

FIG. 1A-C shows a bite plate (1000) from two angles 1A-B, as well as a top plan view 1C. Here the bite plate has a generally U-shaped base (1001) that contacts occlusal surfaces of the teeth, the base having front and back edges, one or both edges having a rim to contact the facial and lingual surfaces of teeth and/or gums. Thus, upper lingual rim (1002), lower lingual rim (1003), upper facial rim (1005) and lower facial rim (1006) are shown. In this instance, the lingual rims contact only the incisors and/or canines, but not the molars. However, the rims can be varied in length to contact all, or a portion, of the teeth. It is preferred that at least one rim contact each tooth, except for badly maloccluded teeth, which by definition are out of alignment.

Although the facial rims can contact all teeth, many children lack wisdom teeth, and there is limited space and often distal appliances further reducing space. Thus, the facial rim can taper off distally, as shown. The lingual rim need not contact more than the incisors, since the vibration is already effectively transmitted via the facial rims, and the lingual rims are for device placement and stability in use. Herbst accommodating bite plates can also be used, with facial rims that do not touch the premolars or molars, as described in 61/824,798, filed May 17, 2013.

Also shown is the stem (1008), which is the portion of the bite plate (1000) that mates with a corresponding socket in the extra-oral housing (not shown here), which contains the power source, vibratory source, processor for controlling the mechanism and providing compliance features.

In more detail, a cylindrical shaft (1009) is shown, having a groove (shown in FIG. 1C as 1013) into which a jump ring (1010) fits, and mates with a corresponding depression in the socket. Optional flare (1112) is also shown, and is configured to provide an appropriate surface so that the user can push the stem into the socket.

FIG. 1C shows a top plan view of the bite plate, more clearly illustrating the core (1007), shaft (1009), flare (1112), pins (1011), groove (1013) and jump ring or coiled spring (1010), as well as the other edge of the overcoat, which provides the actual shape of the bite plate.

FIG. 2A-B shows the core (1007) of the bite plate, typically made from a resin, metal or ceramic having a harder durometer than the outer surface, and providing sufficient rigidity to the stem (1008) so as to allow it to lockingly fit into the socket. Cylindrical shaft (1009) has a groove (1113), into which jump ring (1010) fits. Also seen are locking pins (1011) and other optional feature such as orientation pins, which prevent the bite plate from being inserted upside down. Generally plastics of at least 40 Shore D are used for the core, but metals or ceramics could also be used. A coating is provided over this core, and provides the final shape of the bite plate, as shown in FIG. 1. Such coating should be a biocompatible soft polymer of 40-70 Shore A, and particularly preferred is a medical grade, clear silicone.

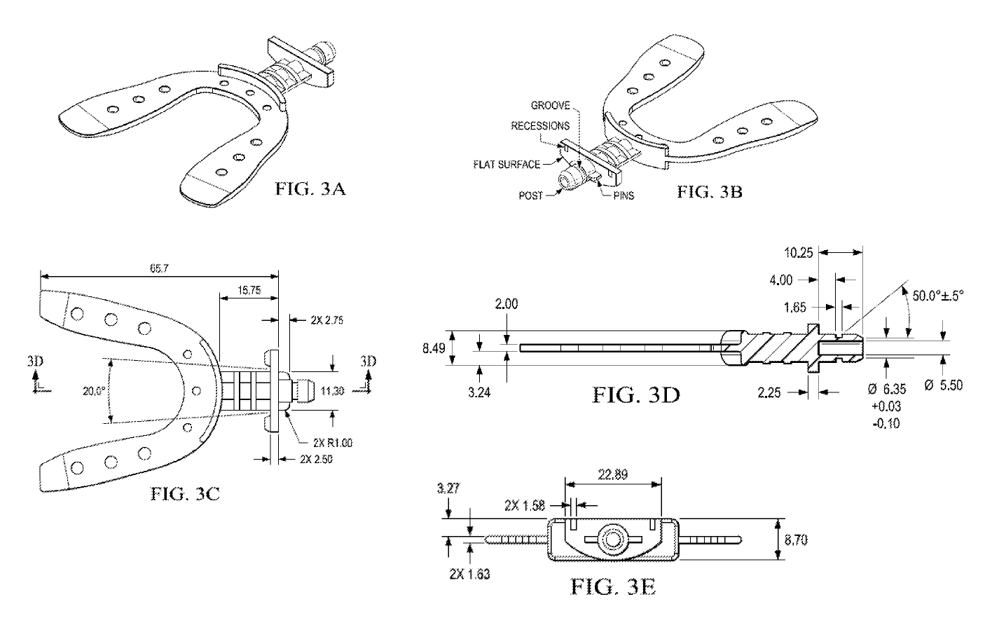

FIG. 3A-E shows the dimensions of the bite plate inner core and connector. Preferably, the connector operably connects (snap fits) into the socket found on the AcceleDent® and AcceleDent® Aura. Using similar connectors allows the bite plates to be interchangeable, and also allows any bite plate inventory to be used even when the driver unit model is updated. Thus, these sizes are valuable for interchangeability of parts. The minimum for interchangeable parts requires the cylindrical post of about 10.25 mm in length by about 6.35 mm in diameter (tolerance in the diagram noted to be +0.03, −0.1) mm with a groove at about 4 mm from the attached end of the post.

The connector has a flared base (flare not shown herein because made from the over-coating material, but can be seen in FIG. 1 etc.) with a flat surface opposite the bite plate, from which protrudes a centrally positioned cylindrical post that is 6-7 (6.35+0.03, −0.1) mm in diameter, 10-11 (10.25) mm in length, and having a groove circumventing the post about half way (4 mm from flat surface), the groove having a width of 1.65 mm. The flared portion is dumbbell in cross section and provides a suitable surface for the thumb and finger to push the bite plate connector into the socket on the driver.

The bottom of the post also has a pair of ˜1.4×3 mm pins (optional) projecting 180° from each other (in the same plane as the occlusal contacting base of the bite plate). These pins have a total spread of 11.30 mm at the topmost edge, but flare 10° on each side (20° total) to reach the flat surface of the base. The pins are 1.63 mm thick, and 2.75 mm high.

The base of the connector also preferably has a pair of recessions ˜1.5 mm wide×˜3 mm long×˜2 mm deep (1.58×3.27×2.5 mm) on the flat surface thereof for engaging clips from the driver, the recessions being about 16-17 mm apart (22.89 mm in spread), and positioned right below the pins. The recessions can be omitted however, if the base is either not flared or is otherwise smaller, such that the remaining post and pins still fit, leaving the engaging clips on the driver free. These dimensions are approximate, and exact dimensions are provided on FIG. 3. Tolerances are as appropriate for the material, while still providing a reversibly locking fit.

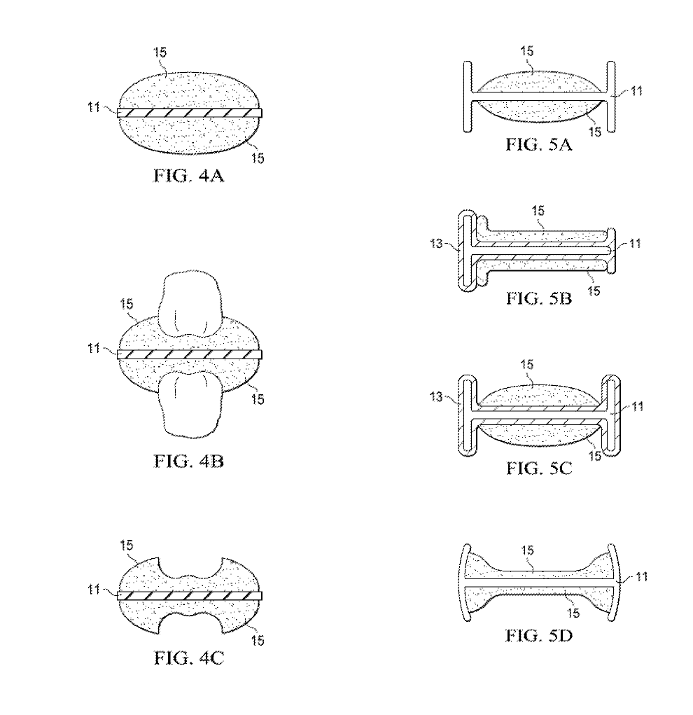

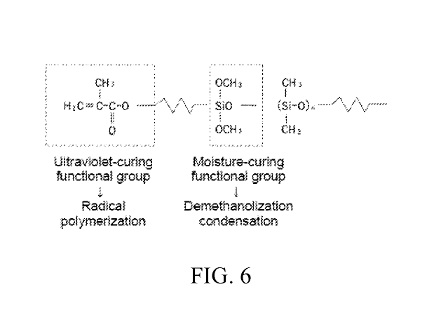

FIG. 4A-C shows the simplest bite plate embodiment, where all rims are omitted on the inner core 11. A thick bead of e.g., light-curable resin 15 is laid thereon, and when pressed by the teeth, per FIG. 4B, will bend around the teeth, providing surfaces that can contact occlusal, as well as lingual and facial surfaces, as shown in FIG. 4C. To the extent that additional facial and lingual surface contact is desired, the bead of material 15 can be made thicker.

FIG. 5A-D show various bite plate cross sections, where an inner core 11 has an optional coating 13, and a curable resin 15 positioned on at least the occlusal surfaces of the bite plate. In use, the patient bites the bite plate, thus molding resin 15 to fit the teeth, and cure is initiated, thus forming a custom bite plate. As shown, the resin 15 can contact only the occlusal surfaces (FIG. 5A-C) but can also contact facial and lingual surfaces of the teeth (FIG. 5D). Cure can be initiated inside the mouth, e.g., with a light pen, or the bite plate can be removed and illuminated.

In use, the cured bite plate is snap fitted to the orthodontic appliance, e.g., an extra-oral vibratory source, the vibratory source activated for at least 10-20 minutes a day, preferably 10-20 minutes twice a day.

Additional information on suitable dental materials is readily available. See e.g., Basic Dental Materials By Manappallil (3d Ed. 2008). Pini N., et al., Advances in dental veneers: materials, applications, and techniques, Clinical, Cosmetic and Investigational Dentistry 4:9-16 (2012). Thus, one of skill in the art can appreciate that there are a great many dental materials available for creating customizable bite plate for use in orthodontic remodelling devices.

Each of the following is incorporated by reference in its entirety.

US20080227046, US20080227047, US20100055634, US20110136070, US20120040300, US20130059263, US20130322018, PCT/US13/36289, 60/906,807, 61/624,242, 61/615,480, 61/824,798, 61/769,507 and 61/673,236. DE19934117; U.S. Pat. No. 5,856,373; 2011/0200973; U.S. Pat. No. 5,017,626; U.S. Pat. No. 4,459,193; U.S. Pat. No. 4,411,625; U.S. Pat. No. 4,771,084; US20050049326.

Basic Dental Materials, by Manappallil (3d Ed. 2008).

While the invention is described above in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. An intra-oral bite plate for an orthodontic remodeling device, said bite plate comprising:
i) a substantially U-shaped surface for contacting occlusal surfaces of teeth;
ii) wherein said U-shaped surface has a layer of curable resin thereon, such that said bite plate can be customized to fit a patient, and
iii) wherein the bite plate has a connector on a midline thereof for reversibly coupling to an extra-oral orthodontic remodeling device.

2. The intra-oral bite plate of claim 1, wherein said connector comprises a cylindrical post of 5.5 mm diameter and 10.25 mm in length.

3. The intra-oral bite plate of claim 2, said cylindrical post having a base end near said bite plate, and further comprising a groove at 4 mm from said base end.

4. The intra-oral bite plate of claim 1, wherein said resin is light curable.

5. The intra-oral bite plate of claim 1, wherein said connector comprises a cylindrical post having a base end near said bite plate, said cylindrical post being about 5.5 mm in diameter and about 10.25 mm in length, and further comprising a groove at about 4 mm from said base end, and wherein said resin is light curable.

6. The intra-oral bite plate of claim 5, wherein said extra-oral orthodontic remodeling device vibrates at a frequency of >20 and <40 Hz and at a force of >0.1 and <0.5 Newtons.

7. The intra-oral bite plate of claim 5, wherein said extra-oral orthodontic remodeling device vibrates at a frequency of 30 Hz and at a force of 0.20-0.25 Newtons.

8. An intra-oral bite plate for an orthodontic remodeling device, said bite plate comprising:
i) a substantially U-shaped surface for contacting occlusal surfaces of teeth;
ii) said U-shaped bite plate having an outside edge having upper and lower rims to contact an upper and lower facial surfaces of teeth and gums;
iii) said U-shaped bite plate having an inside edge having optional upper and lower rims to contact at least a portion of an upper and lower lingual surfaces of teeth and gums;
iv) wherein said U-shaped surface has a layer of curable resin thereon, such that said bite plate can be customized to fit a patient; and
v) wherein the bite plate has a connector thereon for reversibly coupling to an extra-oral orthodontic remodeling device.

9. The intra-oral bite plate of claim 8, wherein said resin is light curable.

10. The intra-oral bite plate of claim 8, wherein said resin is moisture curable.

11. The intra-oral bite plate of claim 8, wherein said resin is heat curable.

12. The intra-oral bite plate of claim 8, wherein said resin is UVA light curable.

13. The intra-oral bite plate of claim 8, wherein said resin is blue light curable.

14. The intra-oral bite plate of claim 8, wherein said resin also contacts said upper and lower rims.

15. The intra-oral bite plate of claim 8, said bite plate comprising a stiff inner core and a biocompatible coating.

16. The intra-oral bite plate of claim 8, wherein said connector comprises a cylindrical post of 5.5 mm diameter and 10.25 mm in length.

17. The intra-oral bite plate of claim 16, said cylindrical post having a base end near said bite plate, and further comprising a groove at 4 mm from said base end.

18. The intra-oral bite plate of claim 8, wherein said an extra-oral orthodontic remodeling device includes a water resistant housing containing a vibratory source operably coupled to an power source operably coupled to an processor for controlling device usages and for recording and transmitting usage compliance data.

19. The intra-oral bite plate of claim 18, wherein said vibrator vibrates at 20-40 Hz and 0.1-0.5 Newtons.

20. An intra-oral bite plate for an extra-oral orthodontic remodeling device, said bite plate comprising:
i) a substantially U-shaped surface for contacting occlusal surfaces of teeth;
ii) wherein said U-shaped surface has a layer of light curable resin thereon, such that said bite plate can be customized to fit a patient, and
iii) wherein the bite plate has a connector on a midline thereof for reversibly coupling to an extra-oral orthodontic remodeling device; and
iv) wherein said connector comprises a cylindrical post of 5.5 mm diameter and 10.25 mm in length.
